(19) United States
(12) Patent Application Publication
(10) Pub. No.: US 2013/0167318 A1
(43) Pub. Date: Jul. 4, 2013

(54) SELF-CONTAINED CAR WASH SYSTEM

(71) Applicant: ECO HOLDINGS, LLC, Richmond, VA (US)

(72) Inventor: BRADY FRY, FREDERICKSBURG, VA (US)

(73) Assignee: ECO HOLDINGS, LLC, RICHMOND, VA (US)

(21) Appl. No.: 13/733,322

(22) Filed: Jan. 3, 2013

Related U.S. Application Data
(60) Provisional application No. 61/582,664, filed on Jan. 3, 2012.

(51) Int. Cl. B60S 3/04

(52) U.S. Cl. CPC B60S 3/04
USPC 15/313; 134/123

(57) ABSTRACT

A self-contained vehicle washing system is described. The system includes a cabinet that includes a container for a cleaning water-wax solution, a pump, a generator, and batteries. The system runs on solar power and does not require external power or waste removal hook-up or tie-in. The system is scalable to be located at a single permanent location or can be portable as desired.

### CROSS-REFERENCE TO RELATED APPLICATION

This application claims the benefit of U.S. Provisional Application No. 61/582,664, filed Jan. 3, 2012, the contents of which are expressly incorporated herein by reference.

### FIELD OF THE INVENTION

The invention relates generally to a commercial car wash system, and more particularly to a self-contained, zero carbon, zero waste, renewable energy sourced, free standing commercial car wash system.

### BACKGROUND OF THE INVENTION

The standard commercial car wash facility uses water and detergent to clean vehicles. There are three basic types of such car wash facilities: 1) self-service high pressure wash, 2) drive or drag through wash with automated scrubbers, and 3) hand-wash with many workers using hoses and buckets; this type can use assembly line techniques to scale up to obtain commercial result. This type is often used by non-profits as fundraising enterprises using volunteer labor. Each method uses a tremendous amount of water and energy. Waste water capture and energy efficiencies are obtained to varying degrees, usually dependent on local regulatory requirements and available capital to the owner.

These types of commercial car wash enterprises consume large amounts of water, energy and chemical detergents. They must dispose of or process large quantities of waste water and chemical waste and must control runoff. They typically rely on mechanical scrubbers, blowers, and pumps that consume large amounts of energy.

In an attempt to minimize the amount of water and energy used, a cleaning solution of water and a blend of waxes was introduced and marketed for personal use as a waterless car wash solution. The solution is sold in plastic squeeze bottles that spray a light mist of the solution over the vehicle where the wax in the solution lifts the dirt from the surface of the vehicle and suspends the dirt in the water misted onto the vehicle surface. The water and wax are removed by hand with microfiber towels. These solutions have typically not been used in commercial car washes.

A mobile cart that provides a low flow of water and no-foam detergents has been developed. The cart is transported to the site of the vehicle to be washed and uses about one pint of water to wash each vehicle. Such systems require that the cart be transported to each vehicle to be washed and is not conducive to high volume washing at a single location.

It would be advantageous to have a system for a self-contained, free-standing, zero emission, zero carbon multi-vehicle commercial car wash. It is desirable that such a car wash is capable of washing a large number of vehicles at a single location without the need to use large amounts of water or energy.

### SUMMARY OF THE INVENTION

The invention provides various exemplary embodiments, including systems and devices that can be implemented as multi-vehicle commercial car washes.

These and other features and advantages of exemplary embodiments of the invention are described below with reference to the accompanying drawings.

### BRIEF DESCRIPTION OF THE DRAWINGS

FIG. 1 is a perspective view of a cabinet for use in the system of the present invention.

FIG. 2 is a perspective view of the solution delivery system according to the present invention.

FIG. 3 is a perspective view of the mechanical system as in FIG. 2.

FIG. 4 is a perspective view of the power scheme of the system as in FIG. 2.

FIG. 5 is a perspective view of the system as in FIG. 2.

FIG. 6 is a perspective view of a structure for containing the system of FIGS. 2-5.

FIG. 7 is another view of the cabinet of FIG. 1.

FIG. 8 is another view of the cabinet of FIG. 1.

FIG. 9 is another view of the cabinet of FIG. 1.

FIG. 10 is another view of the cabinet of FIG. 1.

FIG. 11 is another view of the cabinet of FIG. 1.

FIG. 12 is a schematic view of an implementation the system of the invention.

FIG. 13 is a view of the invention of FIG. 12 implemented as a storage container.

FIG. 14 is a view of the invention of FIG. 12 implemented on a vehicle.

### DETAILED DESCRIPTION

In the following description, a number of materials are identified as suitable for various facets of the implementations. These materials are to be treated as exemplary and are not intended to limit the scope of the claims. A number of dimensions and sizes are identified as suitable for various facets of the implementations. These dimensions and sizes are to be treated as exemplary and are not intended to limit the scope of the claims.

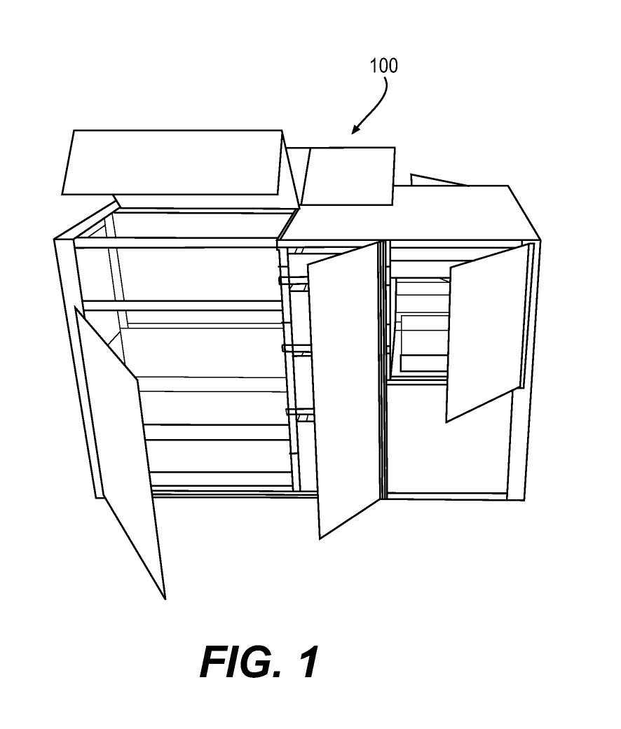

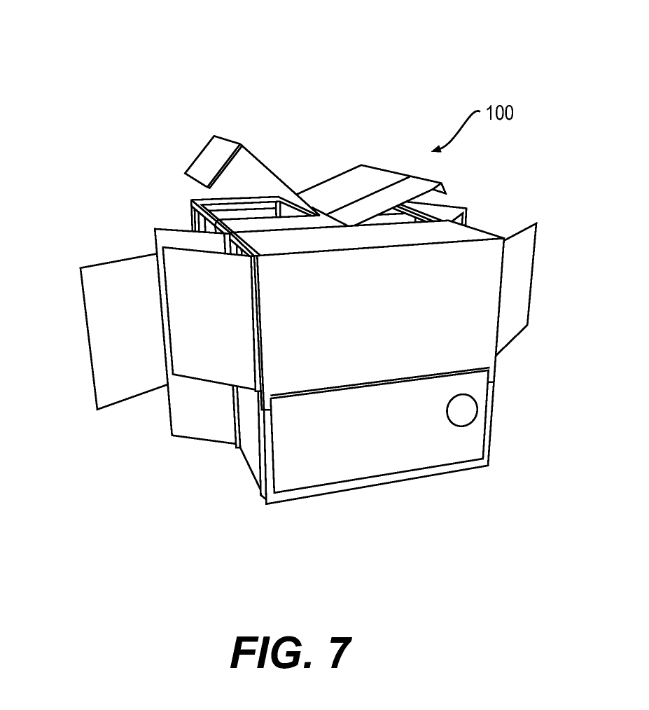

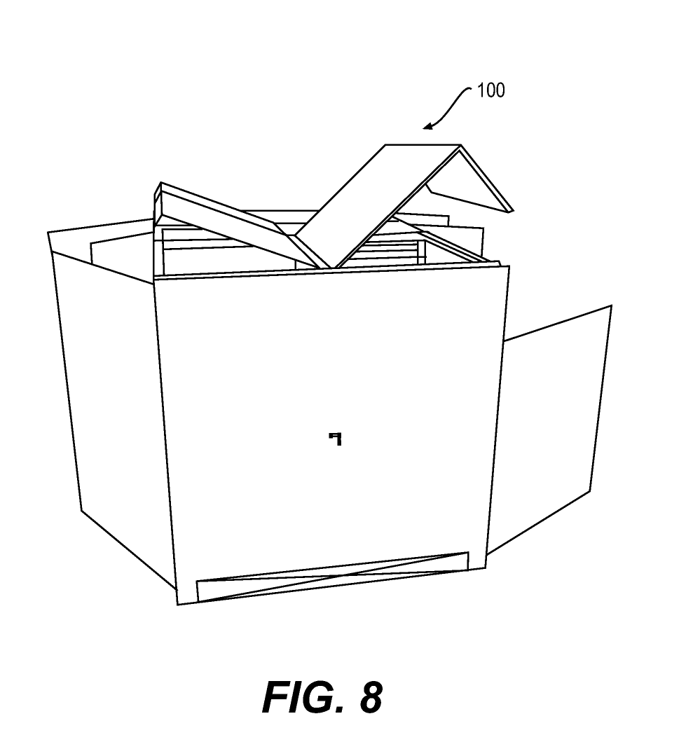

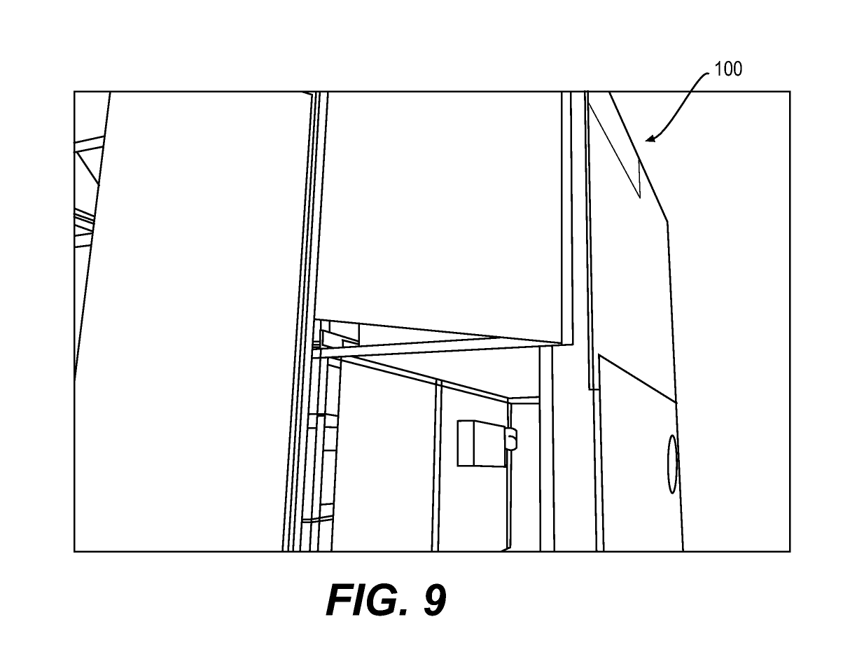

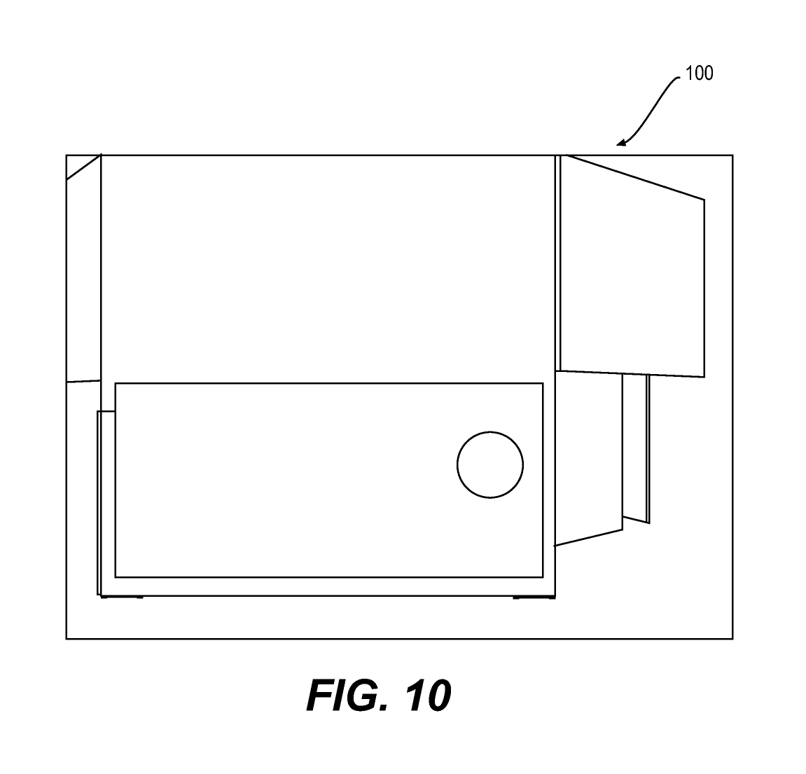

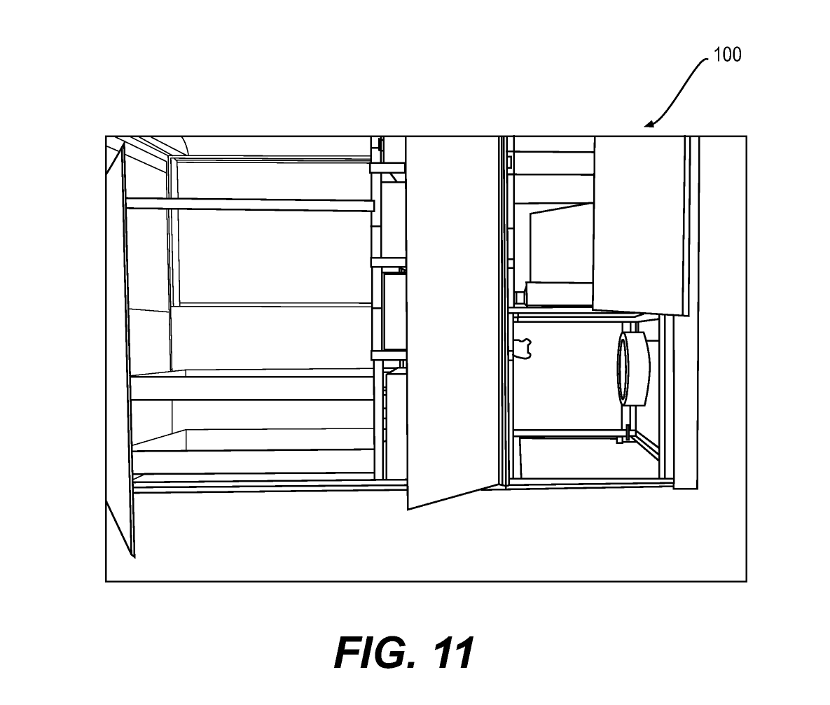

Referring to FIG. 1, cabinet 100 that includes doors and openings to compartments contain the various elements of a commercial car wash system. Cabinet 100 may be made of steel or similar material and can be locked to secure the contents when not in use. In an exemplary implementation, cabinet 100 has dimensions of about 6.5′L×4′H×4′W. Cabinet 100 is not limited to these dimensions, but may be other dimensions as various implementations require. Indeed, cabinet 100 is scalable so that it can be portable. For example, cabinet 100 could be sized and configured for use on a golf cart, ATV, or similar vehicle. Cabinet 100 could be a repurposed steel marine/tractor shipping container. FIGS. 7-11 show other views of cabinet 100.

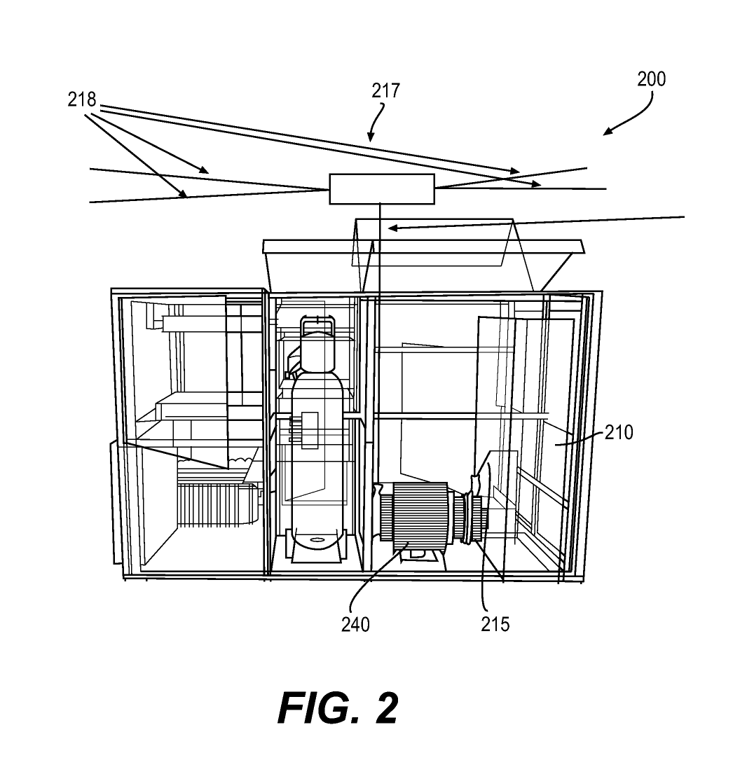

FIGS. 2-5 show system 200 that includes container 210 for holding a water-wax solution, generator 220 that is connected to batteries 230 and solution pump 240. Other drawers and customer tracking and communication devices 260 are optional components of system 200. These components create a self-contained vehicle washing system within cabinet 100. Cabinet 100 is movable and system 200 does not require external hook-ups or tie-ins for energy supply or waste disposal.

Container 210 should be sized to hold a sufficient amount of water-wax solution to wash the number of cars desired between refills. In one implementation, container 210 is a 50 gallon drum of water-wax solution that is sufficient to wash about 400 vehicles.

Energy is supplied to system 200 by generator 220 that is connected to an energy source (not shown) and to batteries 230. Energy sources that may be used include sources that can supply sufficient power to operate the pumps and vacuum systems for cleaning the vehicles. Examples of such sources include solar, wind, a fueled generator, or even the standard power grid. The amount of power necessary to operate four vehicle bays is about the same as can be supplied by an emergency household generator.

When solar energy is used to power the system, the solar panels collect energy from sunlight that is sent to generator 220 that stores the energy in batteries 230. Generator 220 controls the amount of charge that is sent to batteries 230. In one implementation, the solar panel includes polycrystalline silicon solar cells of sufficient size and characteristics to provide sufficient charge to batteries 230. Batteries 230 are typically 12 volt batteries that are capable of powering solution pump 240.

Solution pump 240 is used to pump the water-wax solution from container 210 out through hoses to the vehicle to be washed. In one implementation, solution pump 240 is a 240 or 12 volt booster pump with valves to branching fluid hoses and nozzles. A 240 or 12 volt pump is sufficient to simultaneously wash 4 vehicles due to low pressure solution delivery requirements. In some implementations, a 240 volt pump will prove to require too much power. In such cases, solution pump 240 can be implemented as a 12 volt pump. Such a pump can service four bays and possibly more. In such an implementation, additional pumps 240 may easily be added to the system 200 to create additional washing capacity. The solution is typically misted onto the vehicles.

Accessible from either side of system 200, sliding drawer contains worker supplies including interior cleaners, polishers, micro fiber towels. Customer tracking and communication devices 260 may also be a part of system 200. Each vehicle bay may also be equipped with an individual vacuum for cleaning the vehicle, such as a 12 volt vacuum. Individual vacuums generally require less power than large central vacuums.

In one implementation, solution pump 240 is a standard 240 volt pump or a 12 volt pump modified to accommodate up to four, ⅜″ braided hoses passing up through the steel structure and affixed and accessible from each cleaning bay. Nozzles provide low pressure misting delivery of cleaning solution uniformly over entire vehicle surface by worker trained to apply uniformly while walking around the vehicle. Other implementations permit solution pump 240 to be connected to more or fewer hoses to permit simultaneous washing of more or fewer vehicles, such as 1, 2, 6, 8, 10, 20, or more vehicles. If more than four vehicles are to be washed simultaneously, solution pump 240 would need to be sized accordingly to provide sufficient pressure to each. Once solution pump 240 becomes too large, system 200 may become impractical at a single location due to its size and weight. In such a case, multiple systems 200 may be used at a single location.

Referring again to FIG. 2, solution container 210 is in fluid communication with pump 240 by solution delivery hose 215. Hose 215 may be a steel braided delivery hose or the like. Upon leaving pump 240, the cleaning solution is pumped to manifold 217, and then through delivery hoses 218 to the various cleaning bays.

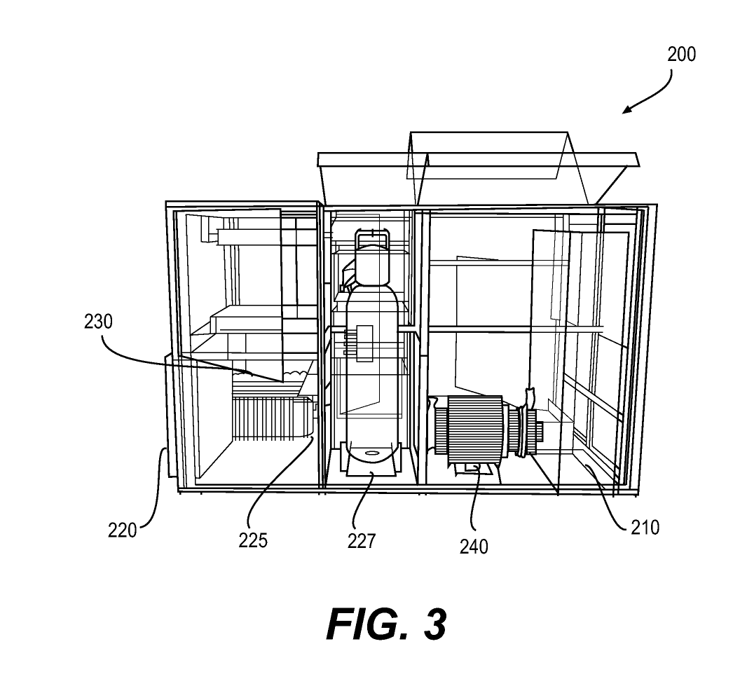

Referring to FIG. 3, solar generator 220 is connected to solar to AC converter 225 to provide power to the units within system 200. System 200 includes air compressor 227 for running detailing tools.

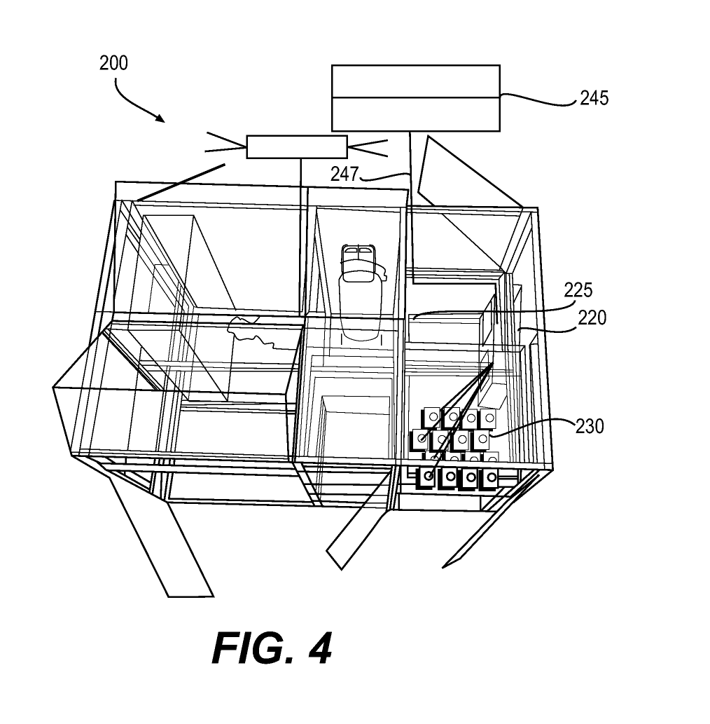

Referring to FIG. 4, solar panels 245 would generally be located on structure 300 where they can be exposed to sunlight. Solar panels 245 are connected to power generator 220 by power cord 247.

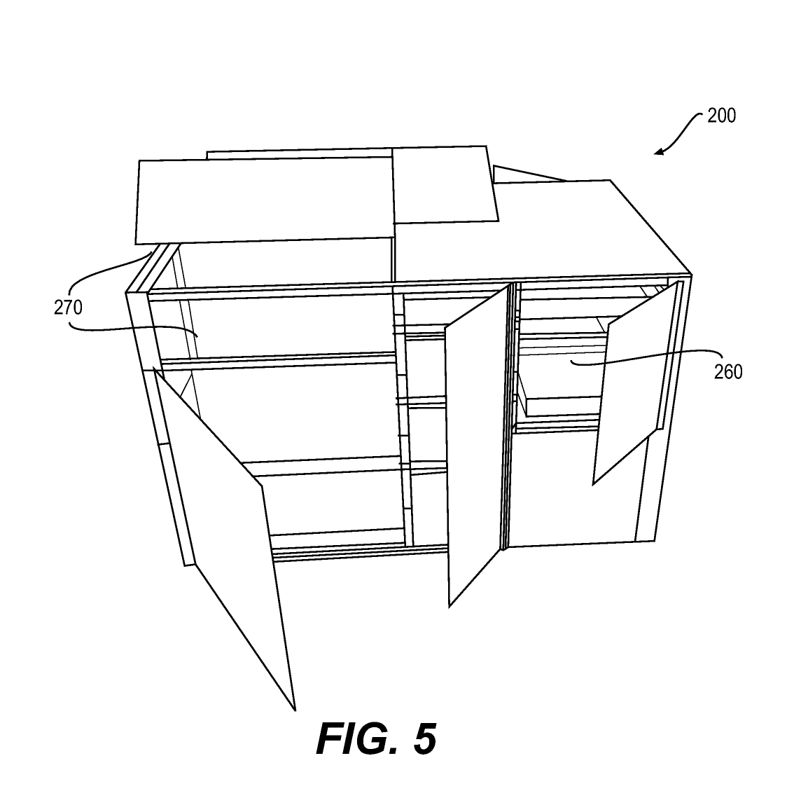

FIG. 5 shows optional customer control and tracking system 260 and interior of cabinet 270 where supplies including tire and detailing equipment and supplies may be stored.

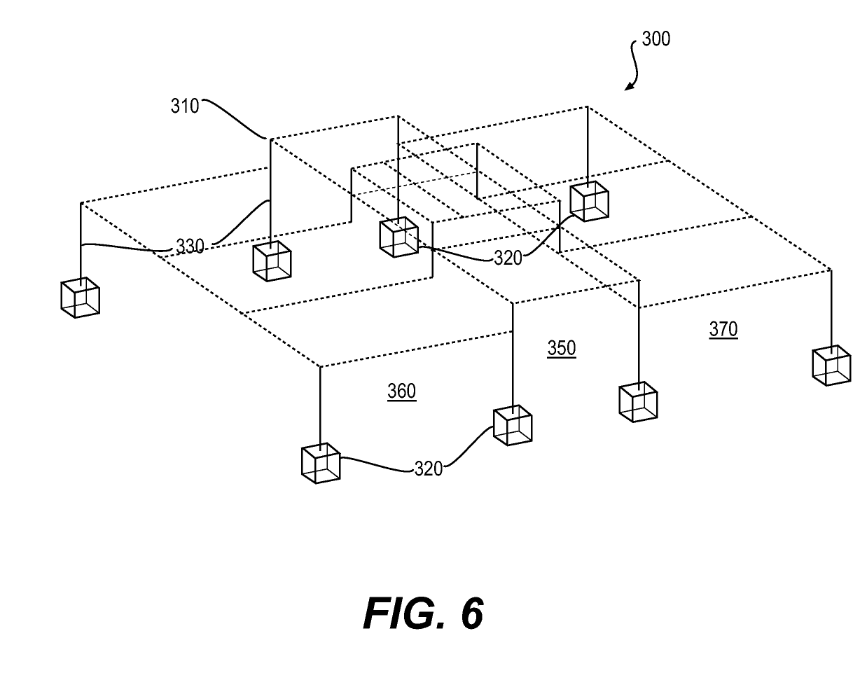

FIG. 6 shows a typical structure where the system described above may be implemented at a single location. As shown in FIG. 6, structure 300 includes steel frame 310 bolted to fourteen concrete poured pedestal footings 320 topped with steel grid 330 supporting canvas cover 340. The initial embodiment provides a central bay 350 where the cabinet and supplies are located with two cleaning bays 360, 370 on either side. Vehicles are driven into cleaning bay 360, 370, cleaned and then parked for pick up by the customer. The concrete footings 320, steel superstructure 310, 330 and canvas cover 340 are collectively rated to withstand winds up to about 200 mph.

In one example, structure 300 may be formed of structural materials having the following specifications:
1. Concrete: 2×2×2 4000 psi blocks with fastening slots pre formed.
2. Steel: Posts: 3″×4″×⅜″ Crossmembers 2×2×¼ powder coated steel.
3. Cover: 70% UV block Canopy Mesh.(×2)

Although one implementation of structure 300 has been described, the invention is not so limited. Larger or smaller structures may be used as desired. For example, structure 300 (either full or half size) may be sheathed in ordinary aluminum siding and the interior built out with ordinary interior wall studs and wallboard. Structure 300 is certified wind stable and the entire system contained in structure 300, can be outfitted shipped and dropped at any location. Canopies may be attached to aluminum (airplane grade) tubular framing welded to the steel structure 300. As structure 300 is wind certified, aluminum frame anchored in 100 pound concrete anchors are sufficient for wind certification. The frame and canopy are removable daily or upon inclement weather.

The free-standing design of the system permits it to be fixed in a permanent location without integrating into existing structures due to the independence of the power and water supplies and waste removal capabilities. There is no need for a one to one solution application apparatus to the vehicle. There is also no requirement of multiple power sources.

The solar panels used in the system are secured in a steel frame above the canvas cover, typically over the central bay in an array. The solar panels are connected to an electric power generator capable of charging batteries to power the solution pump, vacuums, and customer monitoring and communication devices. Solar panels are connected to the generator located within the cabinet which is then connected to the batteries. Total daily power generation requirements can be met with an average of 84 hours of sunlight per week.

The system described herein is used to wash vehicles to remove dirt and other debris. The water-wax solution is sprayed on the vehicles, which is then removed by workers using microfiber cloths. Clean microfiber cloth is used by the workers to polish vehicle surface.

Customer tracking and communication devices can be used to permit customers to order specific cleaning services upon entry to the system. A customer delivers a vehicle to be cleaned to the facility that houses the cleaning system described herein. The customer then goes on his or her way while the vehicle is being cleaned. Once the cleaning is finished, the customer can be notified by conventional electronic devices, such as cell phone, text message, pager, or other mobile communication device.

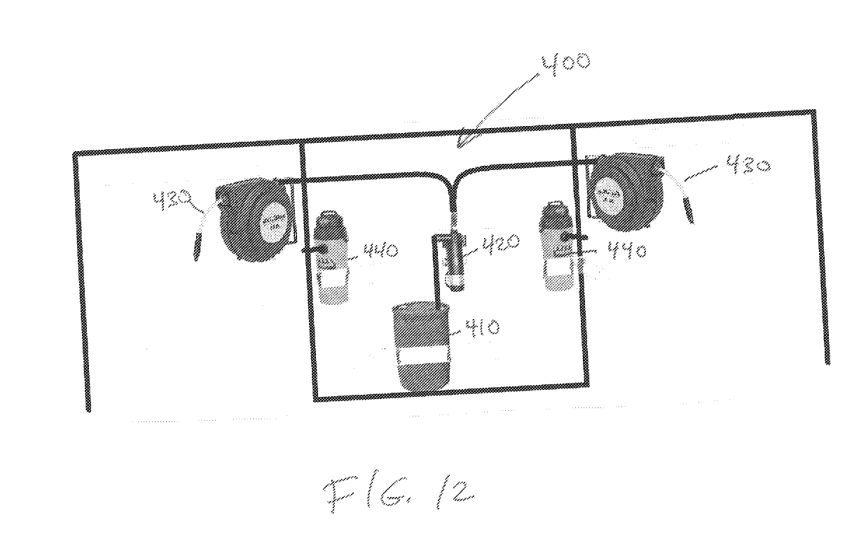

FIG. 12 is a schematic representation of the system 400 according to the present invention. System 400 includes water or solution storage tank 410 that includes a water or cleaning solution used to clean the vehicles, a pump system 420 for pumping the water or solution to hose reel sprayers 430. System 400 may also include vacuum cleaners 440. While system 400 is shown with two reel sprayers 430 and vacuum cleaners 440, the system is not so limited. The system 400 could be scaled up to enable cleaning of 4, 6, 10, or up to 20 vehicles at a time.

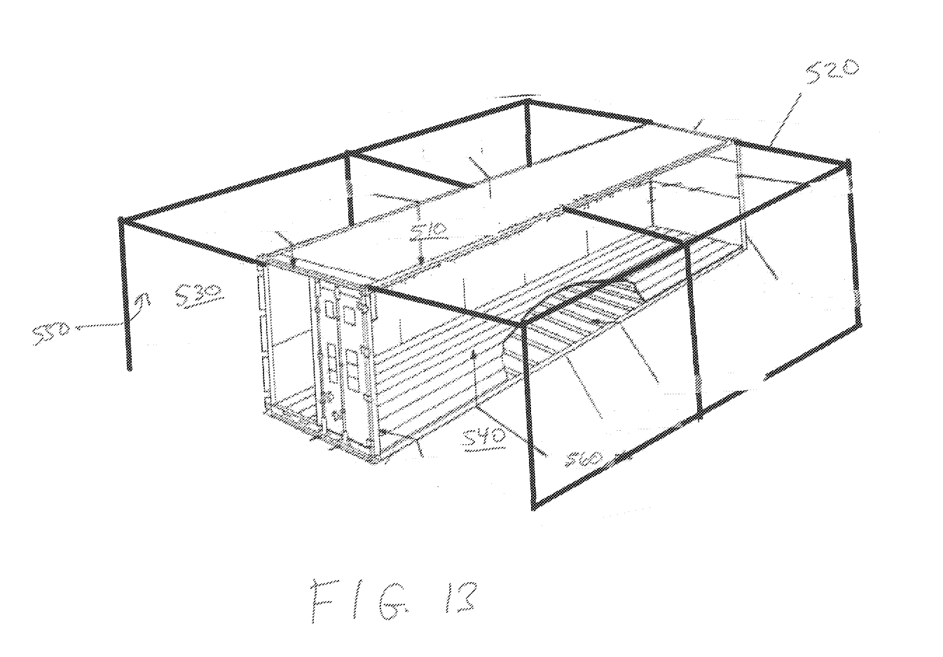

FIG. 13 shows another implementation of the system according to the present invention. The cleaning components are contained within shipping container 510 that can be shipped by truck, ship, or rail and dropped at a particular site. Steel frame 520 can be shipped within shipping container 510 or separately and can be covered with canvas or a similar covering as detailed above. The system is shown with vehicle cleaning bays 530, 540 with entryways 550, 560 for vehicle ingress/egress. The components of the system, including the water storage tank, pump system, batteries, vacuum cleaners, and other parts (not shown) are easily stored within shipping container 510. Solar panels can be implemented on the top or roof of shipping container 510 or steel frame 520, or on any other suitable external surface.

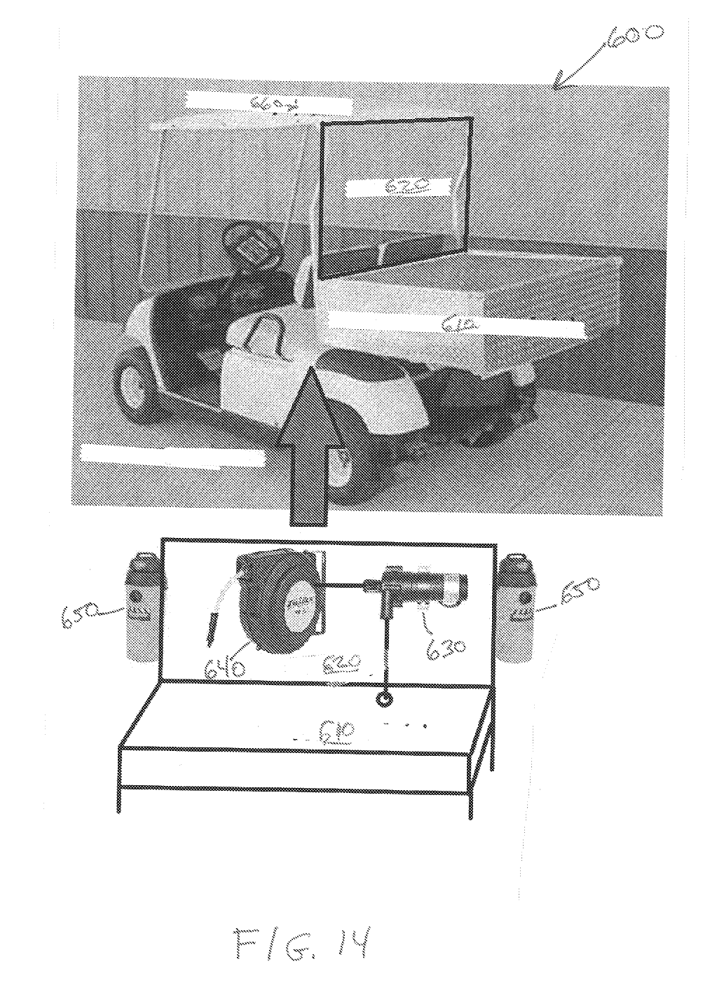

FIG. 14 shows an implementation of the system according to the present invention as part of a vehicle 600, such as a golf cart or similar vehicle. In this way, the system is easily portable and transported from place to place. Water supply tank 610 is shown on the back of vehicle 600. Above water supply tank 610, panel 620 can contain the other components of the system, including pump system 630, hose reel sprayer 640, and dual vacuums 650. Solar panels 660 can be implemented on the top or roof of vehicle 600 to power the system.

The invention has been shown implemented in various ways and sizes. The invention is not limited in size and can be scaled as desired for a particular situation. For example, the system is suitable for use to clean 2, 4, 6, 8, or 20 or more vehicles at a time. Scaling the system would simply require more or larger components, such as larger pumps, batteries, and power supplies.

While the invention has been described in conjunction with specific exemplary implementations, it is evident to those skilled in the art that many alternatives, modifications, and variations will be apparent in light of the foregoing description. Accordingly, the invention is intended to embrace all such alternatives, modifications, and variations that fall within the scope and spirit of the appended claims.

What is claimed is:

1. A vehicle cleaning system comprising:
a cabinet that includes one or more compartments containing:
a container for holding a cleaning solution;
a pump in fluid communication with the cleaning solution;
a generator for providing power to the pump; and
one or more batteries for storing power to be supplied to the pump.

2. The vehicle cleaning system of claim 1, further comprising one or more solar panels connected to the generator to provide solar power to the generator.

3. The vehicle cleaning system of claim 1, further comprising a structure that includes one or more vehicle cleaning bays and a bay that contains the cabinet.

4. The vehicle cleaning system of claim 1, wherein the system is self-contained and does not require an external source of power or external waste removal.

5. The vehicle cleaning system of claim 1, wherein the cabinet further comprises wheels or casters to permit the cabinet to be moved.

6. The vehicle cleaning system of claim 3, further comprising a vacuum cleaner associated with each vehicle cleaning bay.

7. The vehicle cleaning system of claim 1, wherein the pump is a 12 volt pump.

8. The vehicle cleaning system of claim 3, wherein the structure can withstand winds up to about 200 mph.

9. The vehicle cleaning system of claim 3, wherein the structure comprises steel posts that support a canvas canopy.

10. A self-contained vehicle cleaning system that does not require external energy supply or waste disposal, comprising:
a structure that includes one or more vehicle cleaning bays;
a cabinet including one or more compartments containing:
a container for holding a cleaning solution;
a pump in fluid communication with the cleaning solution;
a generator for providing power to the pump; and
one or more batteries for storing power to be supplied to the pump; and
one or more solar panels on an external surface of the structure or the cabinet, the panels being connected to the generator to provide solar power to the generator.

11. The vehicle cleaning system of claim 10, further comprising one or more vacuum systems for cleaning vehicles.

12. The vehicle cleaning system of claim 11, wherein the generator supplies power sufficient to operate the pump and the vacuum systems.

13. The vehicle cleaning system of claim 10, comprising four vehicle cleaning bays.

14. The vehicle cleaning system of claim 10, wherein the pump is a 12 volt pump.

15. The vehicle cleaning system of claim 10, further comprising one or more customer tracking and communications devices for communicating the status of a vehicle wash to customers.

16. The vehicle cleaning system of claim 10, further comprising an air compressor for running detailing tools.

17. The vehicle cleaning system of claim 10, wherein the cabinet is a shipping container.

18. The vehicle cleaning system of claim 10, wherein the cabinet is contained on a vehicle.
